(19) United States
(12) Patent Application Publication
(10) Pub. No.: US 2014/0325374 A1
(43) Pub. Date: Oct. 30, 2014

(54) CROSS-DEVICE USER INTERFACE SELECTION

(71) Applicant: MICROSOFT CORPORATION, REDMOND, WA (US)

(72) Inventors: Olivier Jerzy Dabrowski, Snoqualmie, WA (US); Jim Gilsinan, Redmond, WA (US); Keith Alan Regier, Kirkland, WA (US); Jonathan Bergeron, Seattle, WA (US); Elia Karagiannis, Seattle, WA (US); Troy Ma, Bellevue, WA (US); John Michael Guthmann, Bellevue, WA (US)

(73) Assignee: MICROSOFT CORPORATION, REDMOND, WA (US)

(21) Appl. No.: 13/874,152

(22) Filed: Apr. 30, 2013

(51) Int. Cl. G06F 3/048

(52) U.S. Cl. CPC G06F 3/048
USPC 715/744

(57) ABSTRACT

Computer-readable media, methods, and systems for generating user interfaces across multiple form factor devices are provided. A server is configured to group a plurality of templates into one or more sets having a different layout for categories of devices or applications. The server receives a request from a device for user interface content. In response, the server parses the request to determine a type for the device or a type for an application requesting the user interface content. The devices or applications are classified by the server based on the identified type for the device or application. A set of appropriate user interfaces is selected based on the type of the device or application. The server maps values to one or more attributes associated with the selected set and transmits the user interface content to the device for rendering.

### BACKGROUND

Conventionally, content developers create user interfaces for applications. The content developers may be responsible for developing user interfaces for multiple devices that run an application. The devices may include mobile devices, workstation devices, and tablet devices. Typically, the developers may independently code user interfaces that are device and application specific. In other words, an application (e.g., navigation application) developer may develop at least three independent and individual user interfaces for search applications that execute on mobile devices, workstation devices, and tablet devices. Unfortunately, a developer responsible for several different applications (e.g., search application, e-book application, or shopping application) may need to develop user interfaces for each application and each device.

Assuming three devices and three applications, a developer may be responsible for nine independent user interfaces. As the number of devices and applications increases, the number of user interfaces that need to be generated and maintained increases (e.g., exponentially). And it becomes more difficult for the developer to ensure that the user interfaces are updated as requirements or features of the application change. Accordingly, user interface development and maintenance may consume significant resources (e.g., time, manpower, computing power, or computer storage) as the developer continues creating new applications for new devices.

Because each device is configured with different input/output capabilities and may have unique rendering capabilities, a developer for a web homepage may write code that renders content on a web page. The developer may generate various versions of the webpage that is made available to the device. Each device accessing the web homepage may receive the code and may render the content when the code is executed or interpreted on the device. In some instances, the devices may receive several versions of the code and may ignore versions of the code related to other device types. For instance, a mobile device may receive code for a number of devices (e.g., mobile devices, tablets, or workstations). The mobile device may execute or interpret the code written for the mobile devices.

### SUMMARY

Embodiments of the invention generate user interfaces that vary dynamically based on the device or application that request the user interface. A server device is configured to store a plurality of layouts that are associated with a class of devices or class of applications. The server device is also configured to determine the capabilities of the device or the application that sent the request for the user interface. Based on the detected capabilities, the server assigns a type to the device or application. In turn, the server selects a layout for the user interface based on, among other things, the type and the detected capabilities. The server transmits the user interface and layout to the device for rendering.

In one embodiment, the server may classify the device or the application based on the request. The server may receive a request from a device for user interface content. The server, in some embodiments, parses the request to determine a type for the device or a type for an application requesting the user interface content. The device or the application is classified based on, among other things, the identified type for the device or the identified type of application.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Embodiments of the invention are described in detail below with reference to the attached drawing figures, wherein:

FIG. 1 is a block diagram of an exemplary computing environment suitable for implementing embodiments of the invention;

FIG. 2 is a network diagram illustrating an exemplary computer system having a communication network that includes game consoles, tablet devices, and workstation devices that render user interfaces, in accordance with embodiments of the invention;

FIG. 3 is a block diagram illustrating exemplary executable components of a user interface server, in accordance with embodiments of the invention;

FIG. 4 is a table illustrating exemplary contents for a layout database accessible by the user interface server, in accordance with embodiments of the invention;

FIG. 5 is a view diagram illustrating exemplary user interface customizations available via the user interface server, in accordance with embodiments of the invention;

FIG. 6 is a logic diagram illustrating an exemplary method of generating a user interface, in accordance with embodiments of the invention; and

FIG. 7 is a logic diagram illustrating an exemplary method of classifying devices or applications, in accordance with embodiments of the invention.

### DETAILED DESCRIPTION

The subject matter of this patent is described with specificity herein to meet statutory requirements. However, the description itself is not intended to necessarily limit the scope of the claims. Rather, the claimed subject matter might be embodied in other ways to include different steps or combinations of steps similar to the ones described in this document, in conjunction with other present or future technologies. Although the terms “step,” “block,” or “component,” etc., might be used herein to connote different components of methods or systems employed, the terms should not be interpreted as implying any particular order among or between various steps herein disclosed unless and except when the order of individual steps is explicitly described.

Embodiments of the invention provide a server for generating user interfaces that are rendered on client devices. The server allows a developer to quickly update user interface content associated with applications executing on the client devices. The server may be configured to seamlessly scale across all devices available on the market. In one embodiment, the user interfaces may be configured to vary functionality or features available to the client devices. Thus, the server may react to new applications or new client devices by providing a set of default user interfaces that are common across the client devices.

In some embodiments, the server may implement a device detection and classification component and a template selection and generation component. The user interfaces for the client devices are generated with a set of templates selected by the template selection and generation component. The templates specify layouts for the client devices or applications executing on the client devices. In one embodiment, the user interfaces are generated by the server and the client devices receive the generated user interfaces from the server and display them to the user. Accordingly, the server provides a consistent version of the user interfaces for applications and devices. The templates associated with the user interface are customizable and extensible, which enables the server to scale up and provide appropriate user interface experience across existing and future devices, applications, and markets.

The template selection and generation component of the server may include a database of templates that enable developers to manage and update user interfaces for client devices that typically interact with content maintained by the developer. The database may include sets of consistent layouts that are available for different devices and applications. The layouts simplify the user interface development and maintenance for the developer. For instance, a developer may no longer write specific code for each user interface and device. The developer may leverage the set of templates available for the client devices or applications. The templates may specify layouts and controls (e.g., carousel—graphic elements that reveals additional elements in a set in a looped manner, inline answers, snapshot, scrolling, hints, social controls, or expandos—graphic menu elements that reveals additional tasks for a selected menu item) available for the user interface. The server employs the templates to generate user interfaces for devices or applications without requiring the developer to perform coding and specific implementations for each device.

The server, in addition to template selection and generation component, executes a device classification component. The device classification component, among other things, classifies the device into a specific category. The server may classify the device based on the request received from the device, device information, or feedback received from a user. The server receives the requests from the client device and parses the request to identify a type for the device or application that is requesting the user interface. In one embodiment, the request is a search query.

The server may include a small set of classes (e.g., gaming device, mobile device, tablet, or workstation). The capabilities of the device may be detected based on monitoring at the client device or based on a manufacture name or other device information included in the request. The detected capabilities of the client device allow the server to classify the device into a small number of classes. In one embodiment, the classification may include a device and application classification. For instance, the device classification may include mobile, tablet, or desktop. On the other hand, the application classification may include social, search, or productivity. Upon analyzing the request received from the client device and capabilities of the client device, the server may classify the device as gaming device or tablet executing a search application.

A user interface generation component executed by the server may map values to attributes associated with a selected template to generate the user interface. In certain embodiments, the server selects the template based on the classification of the device or application. The server may enable or disable features associated with the template based on the device capabilities or the application that has requested the user interface. In turn, the server generates the user interface from the selected template and transmits the user interface for rendering at the client device.

The server that executes user interface generation, template selection and generation, and device classification components provides the client devices with dynamic user interface content that are generated based on the capabilities of the device or the features of an application that requested the user interface content. The server and client device are computing devices that have various hardware and software elements. In at least one embodiment, the server device performs all user interface generation processing for the client device. Having briefly described an overview of embodiments of the invention, an exemplary operating environment suitable for use in implementing embodiments of the invention is described below.

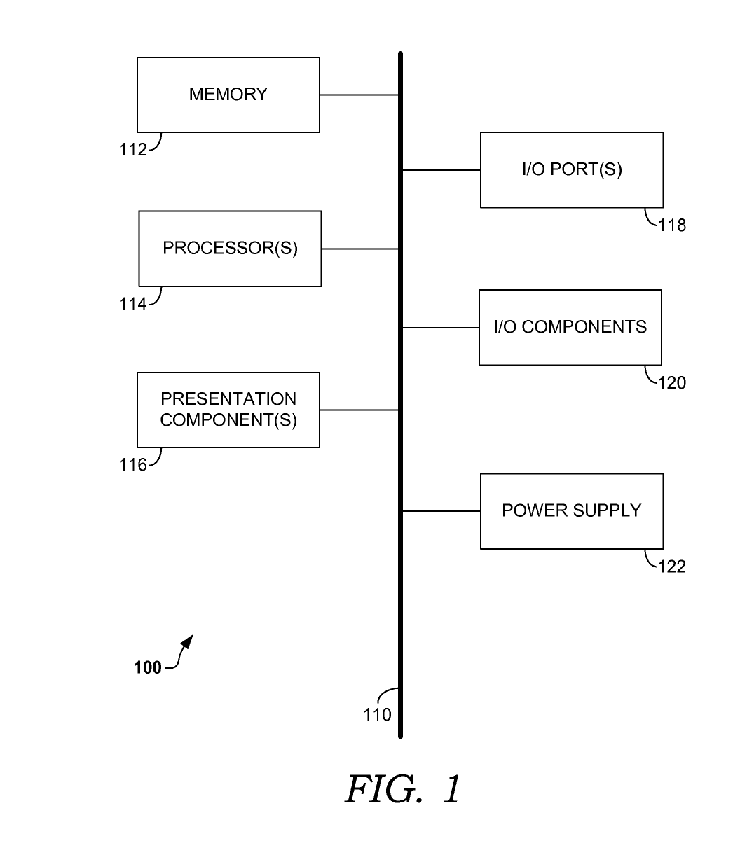

FIG. 1 is a block diagram illustrating an exemplary computing environment suitable for implementing embodiments of the invention. Referring to the drawings in general, and initially to FIG. 1 in particular, an exemplary operating environment for implementing embodiments of the invention is shown and designated generally as computing device 100. Computing device 100 is but one example of a suitable computing environment and is not intended to suggest any limitation as to the scope of use or functionality of the invention. Nor should the computing device 100 be interpreted as having any dependency or requirement relating to any one or combination of components illustrated.

The embodiments of the invention may be described in the general context of computer code or machine-useable instructions, including computer-executable instructions such as program components being executed by a computer or other machine, such as a personal data assistant or other handheld device. Generally, program components including routines, programs, applications objects, components, data structures, and the like, refer to code that performs particular tasks or implements particular abstract data types. Embodiments of the invention may be practiced in a variety of system configurations, including handheld devices, tablet computers, consumer electronics, gaming consoles, general-purpose computers, specialty computing devices, etc. Embodiments of the invention may also be practiced in distributed computing environments where tasks are performed by remote-processing devices that are linked through a communications network.

As one skilled in the art will appreciate, the computing device 100 may include hardware, firmware, software, or a combination of hardware and software. The hardware includes processors and memories configured to execute instructions stored in the computer storage memories. The logic associated with the instructions may be implemented, in whole or in part, directly in hardware logic. For example, and without limitation, illustrative types of hardware logic include field programmable gate array (FPGA), application specific integrated circuit (ASIC), system-on-a-chip (SOC), or complex programmable logic devices (CPLDs). The hardware logic allows a device to generate or render a user interface in accordance with embodiments of the invention. A server device may be configured to classify client devices, select templates based on the device classification, and generate a user interface for rendering by the client device. The client device may request user interface content from the server device and receive the requested user interface content from the server. The user interface provided to the client device may be configured according to capabilities of the device or the features available to an application executing on the client device.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear and, metaphorically, the lines would more accurately be grey and fuzzy. For example, one may consider a presentation component, such as a display device, to be an input/output (I/O) component. Also, processors have memory. One of ordinary skill in the art recognizes that such is the nature of the art and reiterate that the diagram of FIG. 1 is merely illustrative of an exemplary computing device that can be used in connection with one or more embodiments of the invention. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that is accessible by computing device 100 and includes both volatile and nonvolatile media, and removable and nonremovable media. Computer-readable media may comprise computer storage media and communication media.

Computer storage media includes volatile and nonvolatile, removable and nonremovable media implemented in any method or technology for storage of information such as computer-readable instructions, data structures, program modules, or other data. Computer storage media includes, but is not limited to, Random Access Memory (RAM), Read Only Memory (ROM), Electronically Erasable Programmable Read Only Memory (EEPROM), flash memory or other memory technology, CD-ROM, digital versatile disks (DVD) or other holographic memory, magnetic cassettes, magnetic tape, magnetic disk storage or other magnetic storage devices, or any other hardware medium that can be used to encode desired data and that can be accessed by the computing device 100. In an embodiment, the computer storage media can be selected from tangible computer storage media like flash memory. These memory technologies can store data momentarily, temporarily, or permanently. Computer storage media excludes communication media.

On the other hand, communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components 116 include a display device, speaker, printing component, vibrating component, etc. I/O ports 118 allow computing device 100 to be logically coupled to other devices including I/O components 120, some of which may be built in. Illustrative I/O components include a microphone, joystick, game pad, satellite dish, scanner, printer, wireless device, a controller (such as a stylus, keyboard, and mouse) or a natural user interface (NUI), etc.

The NUI processes gestures (e.g., hand, face, and body), voice, or other physiological inputs generated by a user. These inputs may be interpreted as queries, requests for selecting URIs, or requests for interacting with a URI included as a search result, requests for launching an application, or requests of updates to the user interface. The input of the NUI may be transmitted to the appropriate network elements for further processing. The NUI implements any combination of speech recognition, touch and stylus recognition, facial recognition, biometric recognition, gesture recognition both on screen and adjacent to the screen, air gestures, head and eye tracking, and touch recognition associated with displays on the computing device 100. The computing device 100 may be equipped with depth cameras, such as stereoscopic camera systems, infrared camera systems, RGB camera systems, and combinations of these, for gesture detection and recognition. Additionally, the computing device 100 may be equipped with accelerometers or gyroscopes that enable detection of motion. The output of the accelerometers or gyroscopes is provided to the display of the computing device 100 to render immersive augmented reality or virtual reality.

Various aspects of the technology described herein are generally employed in computer systems, computer-implemented methods, and computer-readable storage media for, among other things, generating a user interface. As explained above, a server may execute user interface generation, template selection and generation, and device classification components to generate an appropriate user interface for a client device. The server may process an application request and select a template for the application based on device and application constraints.

In an embodiment, a user interface server provides user interface content for client devices (e.g., gaming devices, tablets, or personal computers). The client device connects to the user interface server via a communication network. In turn, the client devices may request user interface content from the user interface server. The requests from the client devices are parsed and analyzed by the server to establish capabilities of the devices or features of the applications that a user interacts with. Based on this analysis by the server, a user interface may be automatically generated for the client devices.

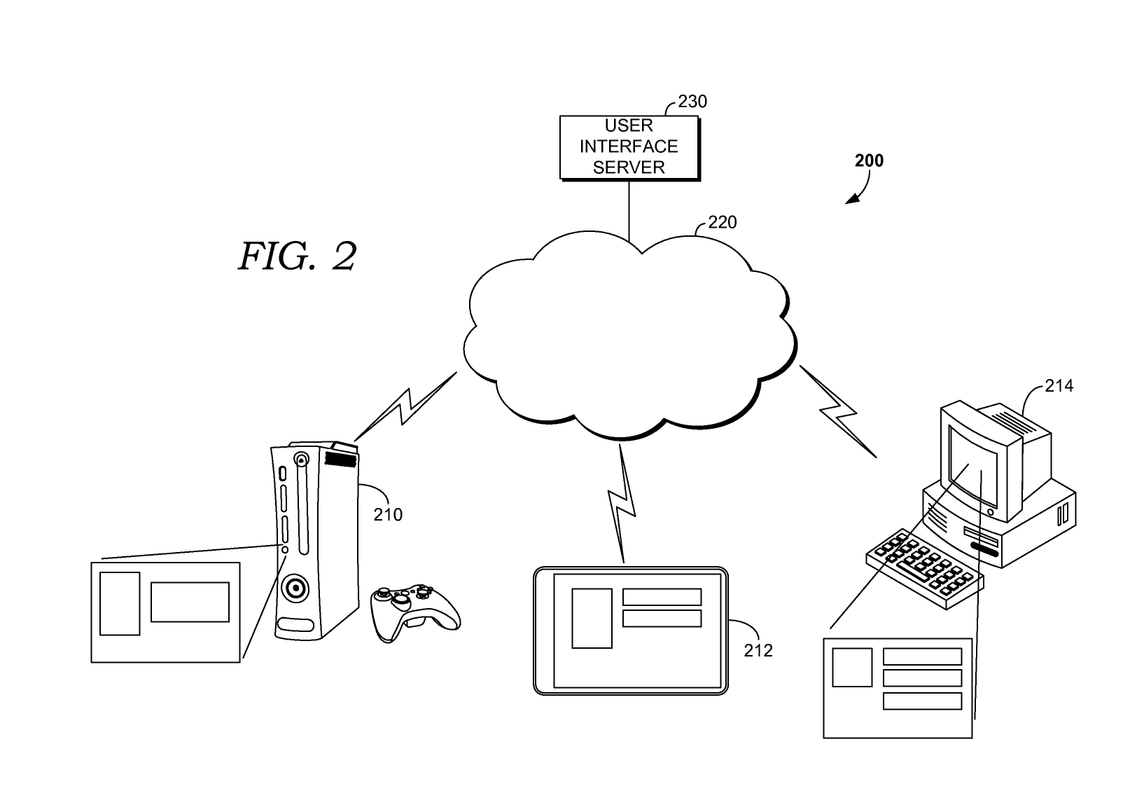

FIG. 2 is a network diagram illustrating an exemplary computer system 200 having a communication network 220 that includes game consoles 210, tablet devices 212, and workstation devices 214 that render user interfaces, in accordance with embodiments of the invention. The computer system 200 provides user interfaces for the client devices based on the capabilities of the client devices (210, 212, and 214). In addition to the client devices (210, 212, 214), the computer system includes a communication network 220 that communicatively connects a user interface server 230 to the client devices (210, 212, and 214).

The client devices 210, 212, and 214 may execute one or more applications that request user interface content. In one embodiment, the client devices may include a gaming device 210, a tablet device 212, or a workstation device 214. The client devices 210, 212, and 214 may also include, among other things, small and large tablet devices, large desktops with touch capabilities, tablet-phone hybrids, gaming or television devices, multimedia players, laptops, PCs, netbooks, smartphones, e-readers, PDAs, and smart watches. Each device may have a capabilities table that specifies device information, like operating system, touch-enabled, speech-enabled, vision-enabled, model, device name, screen size, screen orientations, resolution, dots per inch, etc. The capabilities table may also include application-specific capabilities (e.g., horizontal scroll, video playback, social network connectivity, advertisement-rendering). The applications may include search, gaming, travel, finance, or productivity applications. In response to a request from the applications, the client devices 210, 212, and 214 may generate requests that include device information and application information. The requests may be user interface content requests that are transmitted to the user interface server 230.

The communication network 220 may include a wired network or wireless network. The communication network 220 connects the client devices 210, 212, and 214 to the user interface server 230. The communication network 220 communicates using wired protocols like Ethernet. The communication network 220 may also communicate via wireless protocols, such as code division multiple access (“CDMA”), global system for mobiles (“GSM”), or time division multiple access (“TDMA”), wireless fidelity (Wi-Fi), worldwide interoperability for microwave access (WiMax), as well as others, to transmit communications among the client devices 210, 212, and 214 and the user interface server 230. The wireless communication may be a short-range connection, a long-range connection, or a combination of both a short-range and a long-range wireless telecommunications connection. “Short” and “long” connections, do not mean to refer to the spatial relation between two devices. Rather, one of ordinary skill in the art understands short range and long range to be different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 protocols. The communication network 220 transmits requests from the client devices 210, 212, and 214 to the user interface server 230. The user interface content generated by the user interface server 230 is transmitted over the communication network 220 to the client devices 210, 212, and 214 for rendering.

The user interface server 230 is configured to parse and analyze the request received from the client devices 210, 212, and 214. The user interface server 230, in one embodiment, may receive device information from the client devices 210, 212, and 214 or from a user feedback requested by the user interface server 230. The device information may include device and environmental characteristics and conditions monitored by one or more sensor of the client devices 210, 212, and 214. Exemplary sensors comprise accelerometers, gyroscopes, global position system (GPS) or location, proximity sensors, light sensors, and vibration sensors. The user interface server 203 may classify the device, based on the request and the device information. In turn, the user interface server 230 selects a template for configuring the user interface. The template is completed by the user interface server 230 with values corresponding to content requested by the client devices 210, 212, and 214. The completed template is generated by the user interface and transmitted over the communication network 220 for rendering on the client devices 210, 212, and 214.

In some embodiments, the user interface server 230 executes several components including user interface generation, template selection and generation, and device classification components. The user interface server generates an appropriate user interface based on the layouts selected for a device or an application. The user interface may be for a webpage, an application, or any other software product. The user interface generation component communicates the generated user interface for rendering at the client device.

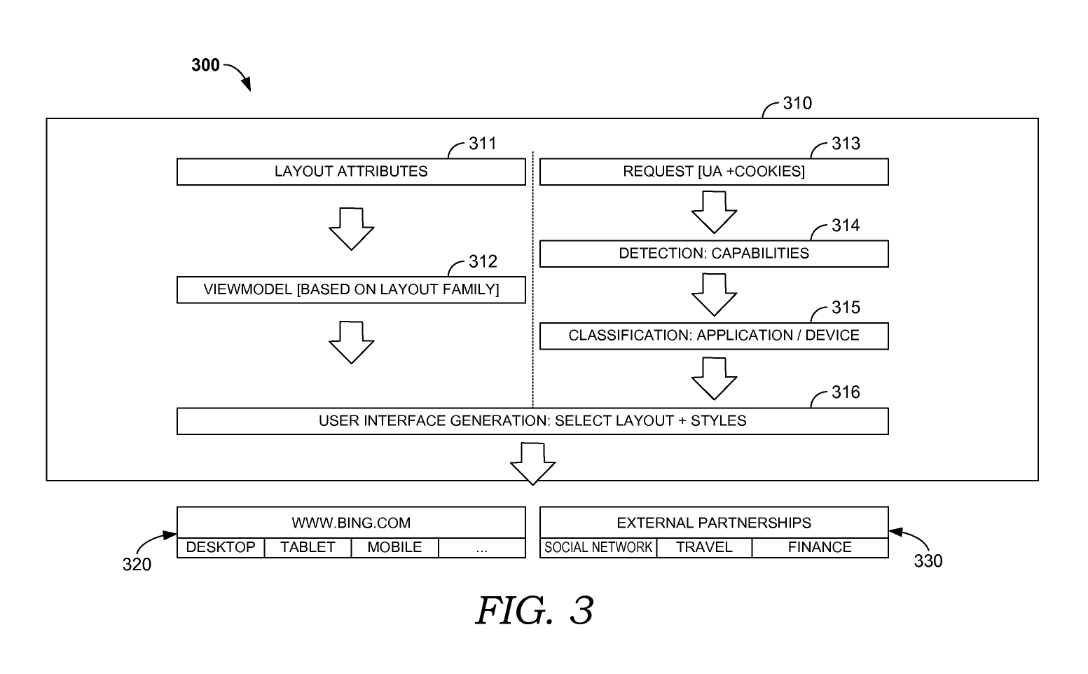

FIG. 3 is a block diagram illustrating exemplary executable components of a user interface server 310, in accordance with embodiments of the invention. The computing system 300 includes the user interface server 310, web pages 320, and applications 330. The user interface server 310, in certain embodiments, may be responsible for generating the user interface content for the web pages 320 and applications 330. The user interface server 310 may generate user interface content for the web pages and applications via templates. The templates maybe stored in a database that organizes the templates based on device or application. The templates support different device capabilities or application functions. In one embodiment, the templates may organize user interface controls and text in different ways. An application or website developer that interacts with the user interface server 310 may select one or more template families that are of interest. One benefit of having the user interface server 310 provide user interface content is efficient scalability for new application or devices. When a new device or application is available, the user interface server 310 may update templates in the family and the developer's application or website may benefit without the developer needing to invest additional resources in providing new code for the new device, application, or website.

In some embodiments, the user interface server 310 is configured to execute a template selection and generation components 311 and 312, device classification components 313, 314, and 315 and the user interface generation component 316. A developer may initially select a template family of the application or website. The template family may include suggested layouts for various device classes or applications. The developer may access and view the template via the template selection and generation components 311 and 312.

The template selection and generation components may include a layout attribute component 311 and a viewmodel component 312. The layout attribute component 311 specifies the attributes that are required or optional for a template family. The attributes may include text, links, advertisements, other user interface controls, or any user interface data element. The developer may provide the layout attribute component 311 with the values for the attributes, especially the required attributes. The viewmodel component 312 allows the developer to specify the specific layouts of interest to allow further customization (e.g., mixing layouts from different template families for an application or device). The customization allows the developer to select a layout or create a custom layout for the application or device. Accordingly, the developer may, in at least one embodiment, provide data for the attributes of a selected template family via an application programming interface.

The user interface server 310 may classify the device based on user feedback, device information, or application information. In one embodiment, the device classification may include at least three categories (e.g., tablet, mobile device, or workstation). One of ordinary skill in the art understands that not all devices are easily categorized. For sake of clarity and in some embodiments, devices that are hybrid devices or that are not identifiable with any of the categories are placed in the workstation category, which may operate as a “catch all.” In other embodiments, user feedback may be solicited to categorize the device in one of the three categories. In addition to the device class selected by the user interface server, applications may also be classified. The applications, in certain embodiments, may be classified by user interface server 310 into several categories including social network, travel, finance, search, gaming, productivity, or shopping.

In an alternative embodiment, the user interface may employ a taxonomy to classify the devices and applications. The device or application taxonomy may include classes and subclasses. The subclassing of the three existing classes may allow for refinement of template families associated with a class or sub-class. Also, subclasses allow for the introduction of new classes when a new product appears in the market: The subclassing may include small tablet and large tablet as subclasses of tablet. The subclassing may also include large desktop, small desktop, and desktop with touch as subclasses of desktop. The subclassing may also include tablet-phone hybrids or smart watches as subclasses of mobile device. The subclassing may also include gaming consoles or smart televisions as subclasses of workstations. The application taxonomy may be based on the device class or subclass, in an embodiment. In other embodiments, the application taxonomy is separate from the device taxonomy. The application taxonomy may allow the user interface server 310 or client devices to restrict functionality or access to device features based on the capabilities of the device that an application is executing on.

The device classification components include a request component 313, a detection component 314, and a classification component 315. The request component 313 receives a request from the client device. The request component 313 parses the request to extract device or application information. The parsed information is transmitted to the detection component 314. The detection component 314 determines whether the parsed information includes, among other things, device manufacture name, model name, application name, operating system, operating system version, touch capabilities, mobile flag, browser type, or browser name. The detection component 314 organizes the parsed information into appropriate properties (e.g. platform, version, application name, screen information, input capabilities). The detection component 314 transmits the properties to the classification component 315.

The classification component 315 may classify the device as one of a desktop, tablet or mobile device based on properties received from the detection component 314. The classification may be based on screen size, name information, application name, and operating system platform. For instance, a small screen size as a screen size property value may cause the classification component to indicate that the device is a tablet or mobile device. A mobile browser initiating the request as the application name property may cause the classification component 315 to indicate that the device is a mobile device. Accordingly, the classification component 315 may utilize any combination of the properties associated with the device to arrive at the classification of the device. If the classification component 315 is unable to classify a device, the classification component 315 may use the desktop classification as a default classification. Alternatively, the classification component 315 may request feedback from the user to select a device category as mobile, tablet, or desktop. For instance, the feedback may request that the user confirm a classification suggested by the classification component 315.

Additionally, the classification component 315 may classify the application 330 executing on the device as one of a search application, gaming application, travel application, finance application, or productivity application based on properties received from the detection component 314. The classification may be based on application name, operating system platform, or requested features. For instance, a search engine as an application property value may cause the classification component to indicate that the application is a search application. A spreadsheet program initiating the request as the application name property may cause the classification component 315 to indicate that the application is a productivity application. Accordingly, the classification component 315 may utilize any combination of the properties associated with the application to arrive at the classification of the application. If the classification component 315 is unable to classify the application, the classification component 315 may use search application as a default classification. Alternatively, the classification component 315 may request feedback from the user to select an application category as search application, gaming application, travel application, finance application, or productivity application.

The user interface generation component 316 receives the classification type of the device or application. In turn, the user interface generation component 316 identifies the appropriate layout and fills the attributes of the layout with the content identified by the developer. The user interface generation component 316 provides the user interface content for the websites 320 and applications 330 requested by the client device.

Accordingly, the user interface server is configured to classify devices and applications that request user interface content. In turn, the user interface server generates the user interface content based on the classification of the device or application. The user interface server selects appropriate templates having layouts for the user interface content and populates the templates with the content identified by a developer of an application or website.

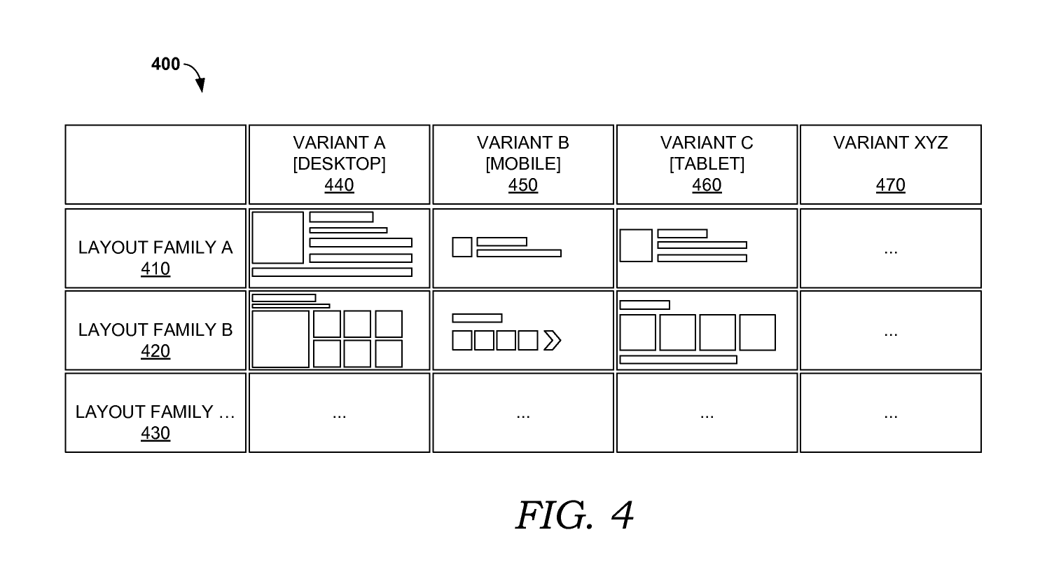

FIG. 4 is a table illustrating exemplary contents for a layout database 400 accessible by the user interface server, in accordance with embodiments of the invention. The layout database 400 includes template families 410, 420, and 430. The template families are selected by a developer to provide a consistent look and feel of user interfaces associated with applications or websites created or maintained by the developer.

In one embodiment, each template family 410, 420, 430 provides layouts for different device classes or application classes. For instance, template family 410 may include independent layouts for desktop devices 440, independent layouts for mobile devices 450, and independent layouts for tablet devices 460. In some embodiments, each template family 410, 420, or 430 may also include layouts that are specific to applications (e.g., multimedia, search, or finance).

The layout database 400 includes templates having various user interface elements like inline answers, snapshot, carousel, expandos, and social features, and advertisements. Each template is placed into a template family 410, 420, or 430 having various layouts that expose a set of user interface views and a consistent data representation across the device and application classes.

A developer of an application or website may use a function call for the template family 410, 420, or 430 to select the templates of interest. For instance, a developer may select a template family 410, 420, or 430 via a “ViewModel” interface. The ViewModel interface may allow a developer to map data to the template family 410, 420, or 430. In one embodiment, some of the templates may be optimized for text, video, or touch. The user interface server may provide the appropriate layout from the template family 410, 420, or 430 selected by the developer.

The user interface server may select from one of the templates in the selected family based on the device classification. Accordingly, the layout database is configured to provide access to templates for the device classes and application classes. In one embodiment, updates to the template families may occur when the new device or application templates are added to the database.

In certain embodiments, a developer may customize the templates provided in the template families A developer may change the media format of a user interface element, may change the type of media available to a template, or swap one template in a template family with another from a different template family. The user interface server allows the developer to customize the templates in the template family if needed.

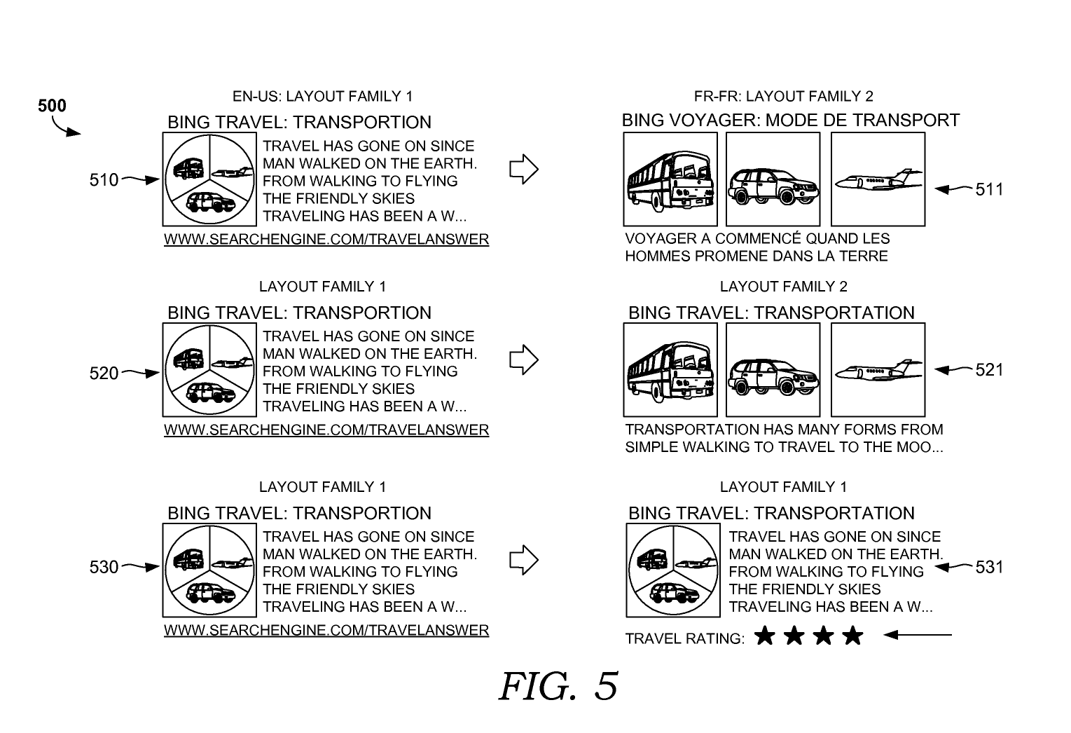

FIG. 5 is a view diagram illustrating exemplary user interface customizations available via the user interface server, in accordance with embodiments of the invention. The customization of the user interfaces may include changing number of media, changing language, or changing content types. The graphical user interfaces 510, 520, and 530 illustrate several customizations available to the developer. The developer may mix content from layout families. For instance, user interface 510 may be from layout family 1 but the developer may prefer user interface 511 from layout family 2, which includes more multimedia content and less text that the template of family 1. The developer may select the template of family 2 for mobile devices and select the template from family 1 for all other devices. Additionally, the developer may select a language constraint for the template of family 2. In one embodiment, the family 2 template may be made available when the request from mobile device includes application properties or device properties indicating that the language on the device or application is French. Otherwise, for all other mobile devices, the template for family 1 is populated by the user interface server to generate the user interface.

User interface 520 may be from layout family 1, but the developer may prefer user interface 521 from layout family 2. The template of family 2 includes more multimedia and less text that the template for family 1. The developer may select the template of family 2 for tablet devices and select the template from family 1 for all other devices.

User interface 530 may be from layout family 1 but the developer may prefer user interface 531 to have a rating as opposed to a link. The developer may replace the link with a rating across all templates in the template family. In one embodiment, the developer may select the rating for mobile devices and select the link for all other devices. In other embodiments, the developer may customize the template for specific applications executed on the client devices. The customization may accomplished based on the data provided by the developer during the selection of the template family. The selected template family may have a layout that is configured with enumerated data types or overloaded operators, which allow the developer to substitute a link data type for a star graphic data type. Alternatively, the selection of the link or star may be a view customization include in the template family. Initially, the developer's customization will not be part of the template family. Instead, the developer's customization will be a customization of a default view for a specific developer. If, however, many of the other developers request the same customization, the system may adopt the customization of the default view as part of the template family.

The developer customization may be based on a preferences or the style of the developer. The developer may prefer using a rating instead of a link that is provided in the default view. The customization option is provided to reduce overall development expense for graphical user interface (GUI) creation and to provide flexibility to allow the developers to express their own creativity in their GUI's if that is preferred over the views provided in the template families.

Accordingly, customization allows a developer to include adjustments to existing templates in the template families. The customization may allow the template family to respond to the device's user-interface-content requests or application's user-interface-content requests in a manner acceptable to the developer. In some embodiments, the developer may use the customization as a short-term fix until an updated template for the template family becomes available. For instance, if a large number of developers are opting for customization, the user interface server may reevaluate the set of templates in the family and may update the templates in the family when a customization for a mobile, tablet, workstation, or application gains popularity in the developer community. The popularity may be measured by a statistical distribution of template usage, where a custom template may be popular if usage of the customization is above a mean or average template usage for the provided template families.

In at least one embodiment, the user interface server executes a method that generates the user interface for a device. The user interface server is configured to populate templates selected by one or more developers. The templates may be populated based on device type or application type associated with a client device that requested user interface content. In turn, the populated templates are communicated from the user interface server to the device for display.

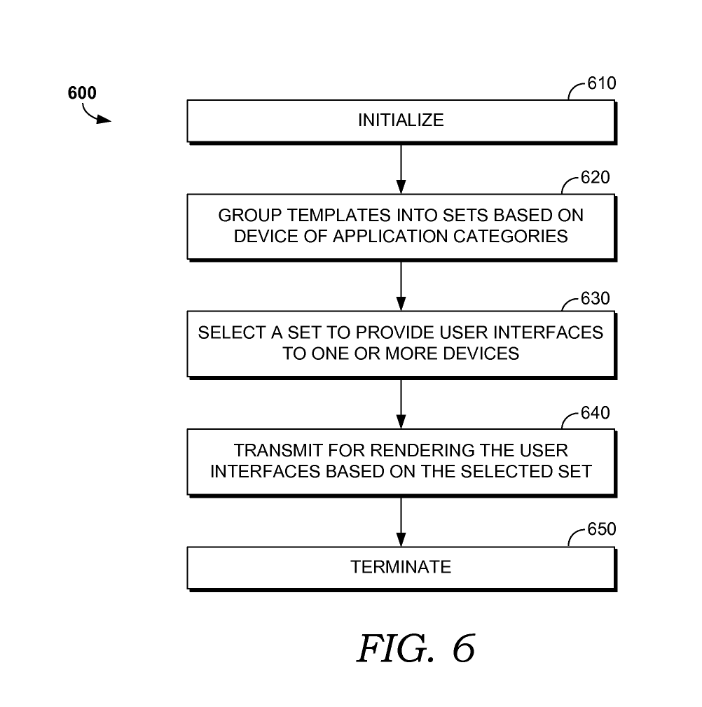

FIG. 6 is a logic diagram illustrating an exemplary method of generating a user interface, in accordance with embodiments of the invention. The method initializes in step 610. The user interface may store a plurality of templates for categories of devices or applications. The templates may be stored in a database. In step 620, the templates are grouped by the user interface server into one or more sets having a different layout for the categories of devices or applications. The layout of the user interface may change based on the category of device or application that requests the user interface. The categories of device may include desktop, mobile phone, tablet, or gaming device. And the categories of application may include multimedia, social, search, games, finance, travel, or productivity.

In one embodiment, the layouts vary based on screen size, screen orientation, or screen resolutions available for the categories of devices or applications. In another embodiment, the layouts may vary based on functionality available for the categories of devices or applications. In still another embodiment, the layouts may vary based on features provided by the applications. Yet in other embodiments, the layouts may vary based on scrolling functionality available for the categories of application.

In turn, the user interface server may select a set from the one or more sets to provide appropriate user interfaces to one or more devices that request the user interface, in step 630. The user interface server may map values to one or more attributes associated with the selected set. The attributes, in certain embodiments, correspond to text, multimedia, language, colors, or ratings rendered in the user interface. The values may correspond to the content that is requested by the application or device.

In other embodiments, the set may be customized to include one or more layouts from other available sets. For instance, the customizations may modify the type of content rendered in the user interface or the location of the content rendered in the user interface. The user interface server, in step 640, transmits the user interface for rendering based on the selected set and corresponding values for the attributes of the selected set. The method terminates in step 650.

In some embodiments, the devices or applications are classified to select the appropriate template family. The devices may be classified based on device information or application information. The devices or applications may be identified in requests from the client devices. Alternatively, the device or application information may be identified in a cookie (e.g., sharing with the server the cookie or any other user tracking information authorized by the user) maintained at the device.

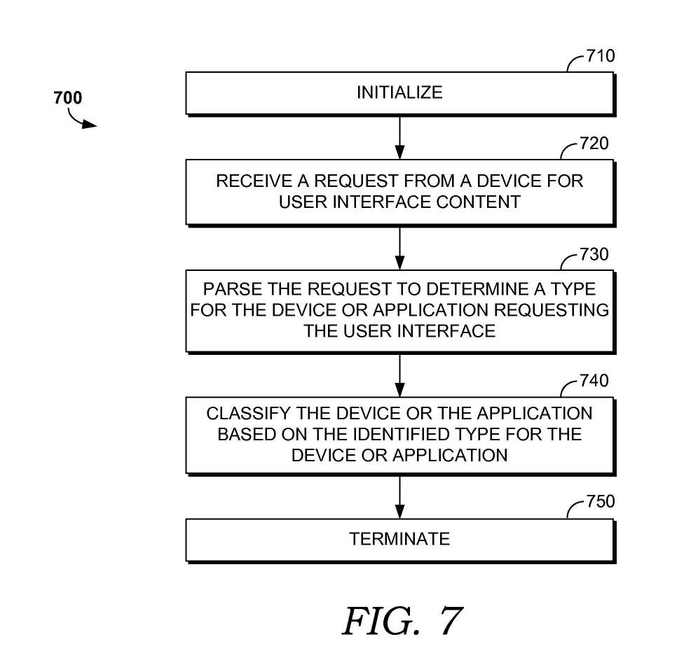

FIG. 7 is a logic diagram illustrating an exemplary method of classifying devices or applications, in accordance with embodiments of the invention. The method initializes in step 710. The user interface server may receive a request from a device for user interface content, in step 720. The request is parsed, in step 730, by the user interface server to determine a type for the device or a type for an application requesting the user interface content. In one embodiment, the type is selected based on device manufacturer, model, name, operating system, touch capabilities, screen orientation, resolutions, dots per square inch, or screen size.

The user interface content may vary based on the classification of the device or the application. For instance, available features or functionality of the user interface varies based on the classification of the device or the application. The user interface server may generate a user interface with fewer features that are accessible to the device or application. Or the user interface server may generate a user interface with more features that are accessible to the device or application.

The user interface server, in step 740, may classify the device or the application based on the identified type for the device or the identified type of application. In an embodiment, the application may be classified as one of a social network application, productivity application, gaming application, travel application, search application, finance application, or multimedia application. In certain embodiments, the device may be classified as one of a mobile device, tablet device, desktop device, or game device. The method terminates in step 750.

In summary, a user interface server is configured to generate user interfaces. The user interface server may group a plurality of templates into one or more sets having a different layout for categories of devices or applications. In response to receiving a request from a device for user interface content, the user interface server may parse the request to determine a type for the device or a type for an application requesting the user interface content. Based on the identified type for the device or the identified type of application, the user interface server is configured to classifying the device or the application. In turn, the user interface server may select a set from the one or more sets to provide appropriate user interfaces to one or more devices based the type of the device or application. The values of one or more attributes associated with the selected set are populated by the user interface server from content provided by a developer. The user interface content is transmitted for rendering based on the selected set and corresponding values for the attributes of the selected set.

The developers may select template families that are populated by the user interface server based on the classification of the device or application requesting content. If needed, the developer may customize the templates within the families by changing user interface elements like, strings, language, image, video, audio, star ratings, links, expandos, carousel, or hints. For instance, a template may include a layout having data (text, link, or star) and media (image, audio, or video) elements. The developer may customize the template by specifying that the data is a link to a web page and media is an image. Alternatively, the developer may customize the template by specifying that the data is a text paragraph and media is a video. The developer may also customize the template available for device or application classes. A class of devices may have a different experience from the other devices in the template family. For instance, the developer may choose to have a desktop device employ a template from template family 1 and have the other devices (mobile, tablets, etc) employ templates from template family 2. The developer may select two template families “ViewModel&ui:desktop=MyAnswerViewModelmplementingLayoutD and ViewModel=MyAnswerViewModelmplementingLayoutC. This will result with a template family in LayoutC being used by the user interface server for all device classes except a desktop where a desktop template of LayoutD will be provided when the device is classified as desktop.

Embodiments of the invention have been described to be illustrative rather than restrictive. It will be understood by persons of ordinary skill in the art that certain features and subcombinations are of utility and may be employed without reference to other features and subcombinations. This is contemplated by and is within the scope of the claims.

The invention claimed is:

1. One or more computer-readable media storing computer-usable instructions for performing a method of generating user interfaces, the method comprising:
storing a plurality of templates for categories of devices or applications;
grouping the plurality of templates into one or more sets having a different layout for the categories of devices or applications;
selecting a set from the one or more sets to provide appropriate user interfaces to one or more devices that request the user interface;
mapping values to one or more attributes associated with the selected set; and
transmitting the user interface for rendering based on the selected set and corresponding values for the attributes of the selected set.

2. The media of claim 1, wherein the attributes correspond to text, multimedia, language, colors, or ratings rendered in the user interface.

3. The media of claim 1, wherein the layouts vary based on screen size, screen orientation, or screen resolutions available for the categories of devices or applications.

4. The media of claim 1, wherein the layouts vary based on functionality available for the categories of devices or applications.

5. The media of claim 1, wherein the layouts vary based on features provided by the applications.

6. The media of claim 1, wherein the layouts vary based on scrolling functionality available for the categories of application.

7. The method of claim 1, wherein the set may be customized to include one or more layouts from other available sets.

8. The method of claim 7, wherein the customizations may modify the type of content rendered in the user interface or the location of the content rendered in the user interface.

9. The method of claim 1, wherein the layout of the user interface may change based on the category of device or application that requests the user interface.

10. The method of claim 9, wherein the categories of device include desktop, mobile phone, tablet, or gaming device.

11. The method of claim 9, wherein the categories of application include multimedia, social, search, games, finance, travel, or productivity.

12. A computer-implemented method for classifying a device, the method comprising:
receiving a request from a device for user interface content;
parsing the request to determine a type for the device or a type for an application requesting the user interface content; and
classifying the device or the application based on the identified type for the device or the identified type of application.

13. The method of claim 12, wherein the application is classified as one of a social network application, productivity application, gaming application, travel application, search application, finance application, or multimedia application.

14. The method of claim 12, wherein the type is selected based on device manufacturer, model, name, operating system, touch capabilities, screen orientation, resolutions, dots per square inch, or screen size.

15. The method of claim 12, wherein the device is classified as one of a mobile device, tablet device, desktop device, or game device.

16. The method of claim 12, wherein the user interface content varies based on the classification of the device or the application.

17. The method of claim 16, wherein available features or functionality varies based on the classification of the device or the application.

18. The method of claim 17, wherein fewer features are accessible to the device or application.

19. The method of claim 17, wherein more features are accessible to the device or application.

20. A server configured to generate user interfaces, the server comprising memories and a processor configured to execute the following method:
grouping a plurality of templates into one or more sets having a different layout for categories of devices or applications;
receiving a request from a device for user interface content;
parsing the request to determine a type for the device or a type for an application requesting the user interface content;
classifying the device or the application based on the identified type for the device or the identified type of application;
selecting a set from the one or more sets to provide appropriate user interfaces to one or more devices based the type of the device or application;
mapping values to one or more attributes associated with the selected set; and
transmitting the user interface content for rendering based on the selected set and corresponding values for the attributes of the selected set.
